(19) United States
(12) Patent Application Publication
(10) Pub. No.: US 2026/0181653 A1
(43) Pub. Date: Jun. 25, 2026

(54) CONTROL RESOURCE SETS AND SYNCHRONIZATION SIGNAL BLOCKS FOR NEW RADIO WITH LESS THAN 5 MHz BANDWIDTH

(71) Applicant: Telefonaktiebolaget LM Ericsson (PUBL), Stockholm (SE)

(72) Inventors: Mirza Uzair BAIG, MÄRSTA (SE); Kittipong KITTICHOKECHAI, JÄRFÄLLA (SE); Gerardo Agni MEDINA ACOSTA, MÄRSTA (SE); Keerthi Kumar NAGALAPUR, GÖTEBORG (SE)

(21) Appl. No.: 19/126,764

(22) PCT Filed: Nov. 2, 2023
(86) PCT No.: PCT/EP2023/080589

§ 371 Date: May 2, 2025

Related U.S. Application Data
(60) Provisional application No. 63/382,318, filed on Nov. 4, 2022.

(51) Int. Cl. H04W 72/23; H04W 72/0453

(52) U.S. Cl. CPC H04W 72/23; H04W 72/0453

(57) ABSTRACT

A method (1100) is provided by a user equipment, UE (112), operating in a reduced channel bandwidth that is less than or equal to 5 MHz. The method includes the UE receiving (1102), from a network node (110), a configuration associated with a control resource set, CORESET. A size of the CORESET in a frequency domain is larger than a size of an active bandwidth part. The UE monitors (1104) at least one Physical Downlink Control Channel, PDCCH, candidate based on the configuration associated with the CORESET. At least one PDCCH candidate located on an edge of the CORESET is punctured.

### TECHNICAL FIELD

The present disclosure relates, in general, to wireless communications and, more particularly to Control Resource Sets (CORESETs) and Synchronization Signal Blocks (SSBs) for 3GPP New Radio (NR) with less than 5 MHz bandwidth.

### BACKGROUND

A Work Item (WI) was approved at RAN #94 and relates to the use cases of Future Railway Mobile Communication System (FRMCS), utilities, and public safety. See, RP-213603, “NR support for dedicated spectrum less than 5 MHz for FR1,” 3GPP TSG RAN meeting #94e, Electronic Meeting, Dec. 6-17, 2021.

In 3GPP Rel-18, the WID defined the following objective to be conducted by RANT:
The following objectives shall be included for dedicated [Frequency Division Duplex (FDD)] spectrum in [Frequency Range 1 (FR1)]:
   Identify and specify necessary changes to NR physical layer with minimum specification impact to operate in spectrum allocations from approximately 3 MHz up to below 5 MHz [RAN1]:
      Restrict to subcarrier spacing of 15 kHz and the use of normal cyclic prefix.
      For [Synchronization Signal Block (SSB)]:
         Reuse [Primary Synchronization Signal (PSS)/Secondary Synchronization Signal (SSS)] specification without puncturing.
         [Physical Broadcast Channel (PBCH)] based on current design.
Identify and specify necessary minimum changes to [Physical Downlink Control Channel (PDCCH)], [Chanel State Information-Reference Signal (CSI-RS)]/[Tracking Reference Signal (TRS)], [Physical Uplink Control Channel (PUCCH)], and [Physical Random Access Channel (PRACH)] for functional support based on existing design, without optimization.

There currently exist certain challenge(s), however. For example, current techniques, solutions, and designs do not cater to seamless NR operation with reduced channels bandwidth. More specifically current NR design and related specifications only support minimum channel BW of 5 MHz.

### SUMMARY

Certain aspects of the disclosure and their embodiments may provide solutions to these or other challenges. For example, methods and systems are provided for allowing the configuration of CORESET with sizes in frequency domain larger than the size of an active downlink (DL) bandwidth part.

According to certain embodiments, a method by a UE operating in a reduced channel bandwidth that is less than or equal to 5 MHz includes receiving, from a network node, a configuration associated with a CORESET. A size of the CORESET in a frequency domain is larger than a size of an active bandwidth part. The UE monitors at least one PDCCH candidate based on the configuration associated with the CORESET. The at least one PDCCH candidate located on an edge of the CORESET is punctured.

According to certain embodiments, a UE operating in a reduced channel bandwidth that is less than or equal to 5 MHz is adapted to receive, from a network node, a configuration associated with a CORESET. A size of the CORESET in a frequency domain is larger than a size of an active bandwidth part. The UE is adapted to monitor at least one PDCCH candidate based on the configuration associated with the CORESET. The at least one PDCCH candidate located on an edge of the CORESET is punctured.

According to certain embodiments, a method by a network node for configuring a UE operating in a reduced channel bandwidth that is less than or equal to 5 MHz includes transmitting, to the UE, a configuration associated with a CORESET. A size of the CORESET in a frequency domain is larger than a size of the active bandwidth part. The network node transmits at least one PDCCH candidate based on the configuration associated with the CORESET. The at least one PDCCH candidate located on an edge of the CORESET is punctured.

According to certain embodiments, a network node for configuring a UE operating in a reduced channel bandwidth that is less than or equal to 5 MHz is adapted to transmit, to the UE, a configuration associated with a CORESET. A size of the CORESET in a frequency domain is larger than a size of the active bandwidth part. The network node is adapted to transmit at least one PDCCH candidate based on the configuration associated with the CORESET. The at least one PDCCH candidate located on an edge of the CORESET is punctured.

Technical advantages of embodiments disclosed herein may me regarded as to reducing an impact of puncturing on a control channel element (CCE) and/or as to reducing an impact of puncturing on a SSB.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the design of a PDCCH CORESET, according to certain embodiments;

FIG. 2 illustrates different example designs for 2 symbol CORESETs under reduced bandwidth operation, according to certain embodiments;

FIG. 3 illustrates an example CORESET with a punctured AL 8 PDCCH candidate, according to certain embodiments;

FIG. 4 illustrates an example time frequency structure of SSB, according to certain embodiments;

FIG. 5 illustrates an example communication system, according to certain embodiments;

FIG. 6 illustrates an example UE, according to certain embodiments;

FIG. 7 illustrates an example network node, according to certain embodiments;

FIG. 8 illustrates a block diagram of a host, according to certain embodiments;

FIG. 9 illustrates a virtualization environment in which functions implemented by some embodiments may be virtualized, according to certain embodiments;

FIG. 10 illustrates a host communicating via a network node with a UE over a partially wireless connection, according to certain embodiments;

FIG. 11 illustrates an example method by a UE operating in a reduced channel bandwidth that is less than or equal to 5 MHz, according to certain embodiments; and

FIG. 12 illustrates an example method by a network node for configuring a UE operating in a reduced channel bandwidth that is less than or equal to 5 MHz, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., Mobile Switching Center (MSC), Mobility Management Entity (MME), etc.), Operations & Maintenance (O&M), Operations Support System (OSS), Self Organizing Network (SON), positioning node (e.g., Evolved-Serving Mobile Location Centre (E-SMLC)), etc.

Another example of anode is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. These terms are used to refer to any kind of network node, which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), or any of the other network nodes described above.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

Certain embodiments described herein consider the impact of control channel element (CCE) and Physical Broadcast Channel (PBCH) puncturing. According to certain embodiments, for example, solutions are provided for a CORESET that aims at utilizing the unaffected part of the CORESET more efficiently such as, for example, by allowing the configuration of a CORESET with sizes in frequency domain larger than the size of active DL bandwidth part.

When a CORESET with size larger than DL active bandwidth part is considered, there can be both non-punctured and punctured PDCCH candidates in the CORESET. According to certain embodiments disclosed herein, methods and systems are provided for PDCCH monitoring limits that introduce new interpretation of the existing PDCCH monitoring limits or to introduce new PDCCH monitoring limits when the UE is expected to monitor some PDCCH candidates which are punctured.

As another example, according to certain embodiments, methods and systems are provided for SSB/PBCH that allow repetition of the same SSB candidate within an SSB burst. The solutions for SSB/PBCH aim at compensating for the PBCH performance impacts due to puncturing when operating with reduced bandwidth. For example, in particular embodiments, methods and systems are disclosed that introduce new lower default SSB periodicity value and allow repetition of the same SSB candidate within an SSB burst.

### CORESET

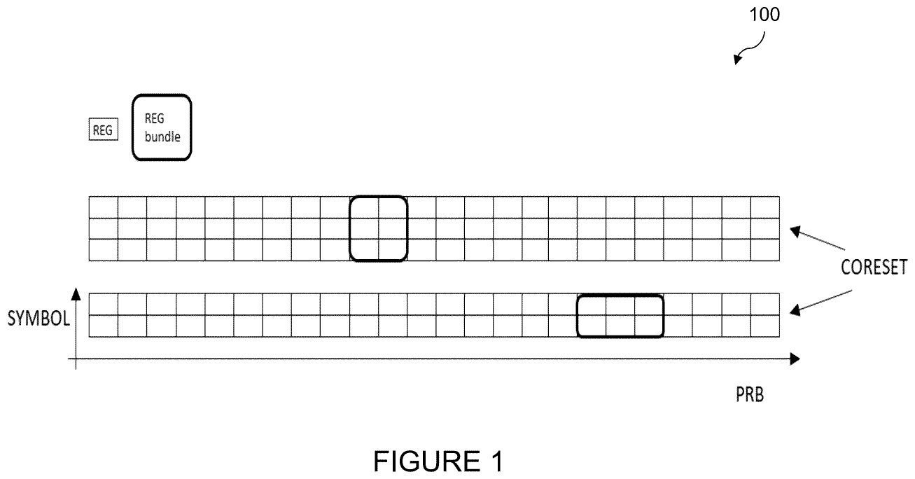

FIG. 1 illustrates an example design of a PDCCH CORESET 100, according to certain embodiments. Specifically, FIG. 1 illustrates a PDCCH CORESET structure with non-interleaved CCE-to-Resource Element Group (CCE-to-REG) mapping. Here, the only allowed configuration for 2 symbol CORESET is a CCE (equivalently, Resource Element Group (REG) bundle) of size 3 Physical Resource Blocks (PRBs). Similarly, for a 3 symbol CORESET, the allowed configuration is a size 2 PRB CCE.

Typically, CORESET size is defined in multiples of 6 PRBs. When operating in a narrow channel bandwidth, the UE is not expected to receive PDCCH outside an active bandwidth part. For instance, when operating with a reduced bandwidth of 3 MHz and a subcarrier spacing of 15 kHz, the bandwidth can accommodate 15 PRBs while accounting for the guard band. When reusing the current design of CORESET, 3 PRBs among the 15 PRBs will be unused. For example, a short CORESET of size 12 PRBs will be used, which leads to a waste of scarce resources such as, for example, bandwidth. According to certain embodiments described herein, the constraint requiring that the CORESET be a multiple of 6 PRBs is relaxed. By relaxing this constraint, more frequency domain resources can be utilized when operating with reduced bandwidths.

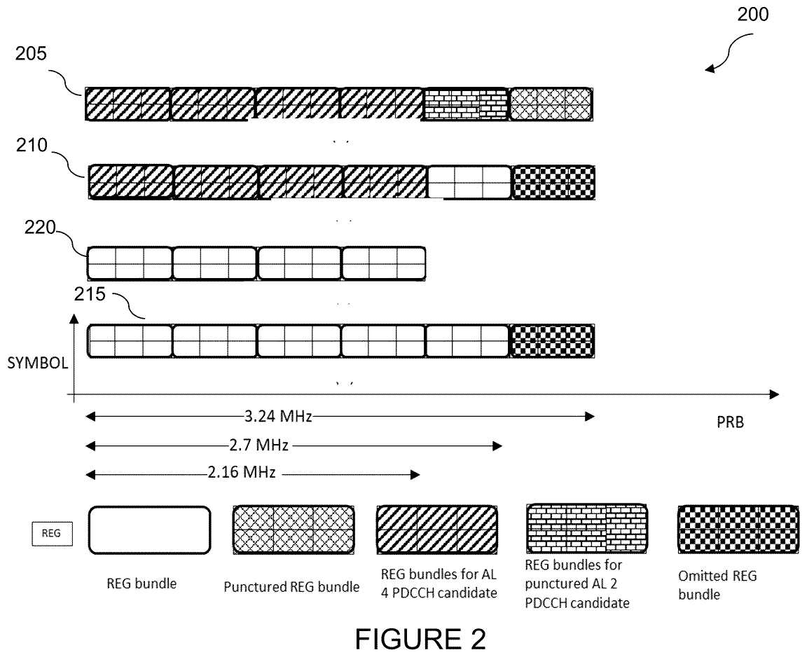

FIG. 2 illustrates different example designs 200 for 2 symbol CORESETs under reduced bandwidth operation (i.e., narrow channel bandwidth operation) that assumes a bandwidth less than or equal to 3 MHz. CORESET 205, CORESET 210, and CORESET 215 are long CORESETs (that may require omitting some REG bundles and/or allow transmitting punctured PDCCH candidates. More specifically, CORESET 205 illustrates a long CORESET with one non-punctured Aggregation Level (AL) 4 PDCCH candidates and one punctured AL 2 candidate. CORESET 210 illustrates a long CORESET with one non-punctured AL 4 PDCCH candidates.

CORESET 220 is a short CORESET that limits the number of PDCCH candidates to transmit and limits the AL to transmit.

Some additional example embodiments for NR operation in narrow channel bandwidth encompassing less than 5 MHz are described below. In more particular embodiments, the reduced bandwidth operation may be less than or equal to 3 MHz. In the following, the term CORESET size is used to refer to CORESET size in frequency domain (in PRBs).

In a particular embodiment, the CORESET size for reduced bandwidth operations is not restricted to a multiple of 6 PRBs.

In a particular embodiment, the allowed CORESET size for reduced bandwidth operations is defined as a multiple of 3 PRBs such as, for example, a long CORESET such as CORESET 215 with 15 PRBs.

In a particular embodiment, the allowed CORESET size for reduced bandwidth operations is defined as a multiple of

$$\frac{6}{{N}_{symbol}^{CORESET}}$$

where

$${N}_{symbol}^{CORESET}$$

is the time duration of the CORESET in OFDM symbols.

In a particular embodiment, a CORESET size larger than the size of the active bandwidth part is considered for generating the PDCCH candidates when operating with reduced bandwidth.

In a further embodiment, the CORESET size considered for generating the PDCCH candidates when operating with reduced bandwidth is upper bounded. That is, there exists a maximum allowed CORESET size to be considered for generating the PDCCH candidates when operating with reduced bandwidth.

In a further embodiment, when a CORESET size larger than the active bandwidth part is considered for generating PDCCH candidates, the CORESET size in PRBs depends on the CORESET CCE-to-REG mapping (interleaved or non-interleaved).

In a further embodiment, the CORESET size considered is given by

$$⌈ \frac{{N}_{BWP}}{6} ⌉ \times 6 P R B s ,$$

where N_{BWP} is the number of PRBs in the active bandwidth part of the reduced bandwidth. In a further embodiment, all CCEs in the CORESET larger than the active bandwidth part are considered for generating PDCCH candidates and the CCEs that are not contained within the active bandwidth part are punctured. As illustrated by CORESET 205 in FIG. 2, the rightmost CCE is punctured.

In a further r embodiment, when a CORESET size larger than the active bandwidth part is considered for generating PDCCH candidates and the CCEs that are not contained within the active bandwidth part are punctured, only PDCCH candidates with certain AL(s) are allowed to be punctured. In one example only PDCCH candidates with AL larger than 4 are allowed to be punctured.

In a further embodiment, when a CORESET size larger than the active bandwidth part is considered for generating PDCCH candidates and the CCEs that are not contained within the active bandwidth part are punctured, the unpunctured PDCCH candidates can coexist with punctured PDCCH candidates. As illustrated by CORESET 205 in FIG. 2, the PDCCH candidate with AL 4 coexists with the punctured PDCCH candidate with AL 2.

In a further embodiment, when a CORESET size larger than the active bandwidth part is considered for generating PDCCH candidates, the PDCCH candidates are selected such that the maximum number of PDCCH candidates being punctured are limited to a certain fixed number.

In a further embodiment, when a CORESET size larger than the active bandwidth part is considered for generating PDCCH candidates, the PDCCH candidates are selected such that the puncturing of the CCEs exceeding the active bandwidth part impacts only those PDCCH candidates located on the edges of the CORESET.

In a further embodiment, when a CORESET size larger than the active bandwidth part is considered for generating PDCCH candidates, the PDCCH candidates are selected such that the quantity of puncturing of the CCEs exceeding the active bandwidth part depends on the CORESET CCE-to-REG mapping (interleaved or non-interleaved).

In a further embodiment, when a CORESET size larger than the active bandwidth part is considered for generating PDCCH candidates, the PDCCH candidates are selected such that the quantity of puncturing of the CCEs exceeding the active bandwidth part is at most 2 for interleaved CCE-to-REG mapping.

In a particular embodiment, the CCEs that exceed the active BWP resulting from generation of PDCCH candidates using a CORESET size larger than the active bandwidth part are omitted for determining PDCCH candidates with different ALs. As illustrated by CORESET 210 of FIG. 2, the right most CCE is omitted for determining the PDCCH candidates.

The example embodiments described above may be applied to any CORESET including CORESET with ControlResourceSetId other than 0 as well as the CORESET with ControlResourceSetId=0.

### PDCCH Monitoring Limits

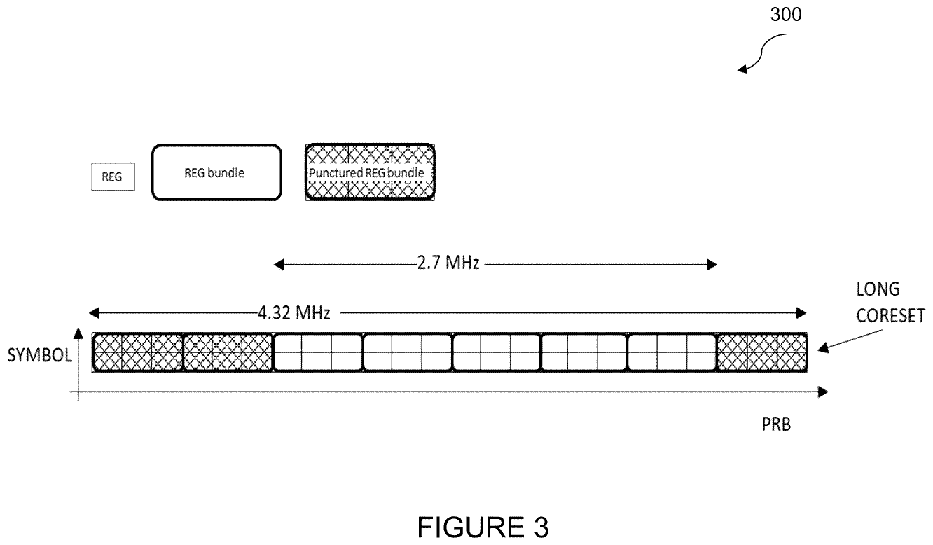

FIG. 3 illustrates an example CORESET 300 with a punctured AL 8 PDCCH candidate, according to certain embodiments. Only 5 CCEs are to be monitored by the UE. A long CORESET size of 4.32 MHz is needed to transmit a 2 symbol PDCCH CORESET with AL 8. To operate in a narrow channel bandwidth, this requires puncturing of CCEs (equivalently REG bundles, assuming non-interleaved mapping). Here, the UE will decode only 5 CCEs for decoding an AL 8 PDCCH candidate.

Tables 10.1-1, 10.1-2, 10.1-2A, 10.1-2B, 10.1-3, 10.1-3A and 10.1-3B in 3GPP TS 38.213 v.17.3.0, set the maximum limits for the UE on the number of monitored PDCCH candidates (blind decodes) and non-overlapped CCEs for channel estimation. These limits are put in place to limit the UE PDCCH search complexity as NR PDCCH design allows overbooking of search spaces.

The PDCCH monitoring limits defined in 3GPP TS 38.213 v.17.3.0 do not consider punctured PDCCH candidates. However, as illustrated in FIG. 3, with puncturing the UE is not monitoring as many resource blocks as before.

There are different ways of defining PDCCH monitoring limits when some PDCCH candidates are punctured. This implies different UE behaviors in monitoring non-punctured and punctured PDCCH candidates. The PDCCH monitoring limits accounting for non-punctured and punctured PDCCH candidates is foreseen to allow the BS to use the UE monitoring capabilities more efficiently (e.g., battery saving-wise).

Certain example embodiments are described below for NR operation in reduced bandwidth. As used herein, the term PDCCH monitoring limit refers to the maximum limit on the number of monitored PDCCH candidates (blind decodes) or the maximum limit on the number of non-overlapped CCEs for channel estimation, or both.

According to certain embodiments, a method includes reusing the existing PDCCH monitoring limits with different interpretations in reduced bandwidth operation. For example, in a particular embodiment, existing PDCCH monitoring limit values are applied but only on non-punctured candidates.

As another example, in a particular embodiment, existing PDCCH monitoring limit values are applied but only on candidates which are not punctured beyond a certain threshold such as, for example, those candidates with the number of punctured CCEs that are smaller than x % of the corresponding AL of the PDCCH candidate.

In a particular embodiment, existing PDCCH monitoring limit values are applied to all candidates regardless of whether it is punctured or not.

According to certain other embodiments, a method includes defining/providing/receiving new PDCCH monitoring limits for NR operation with narrow channel bandwidth. In one example, in a particular embodiment, the new PDCCH monitoring limits are larger compared to the corresponding existing limits for the same subcarrier spacing configuration.

How the new PDCCH monitoring limits are applied to PDCCH candidates can follow different interpretations as described above, for example.

According to still other embodiments, a method includes defining/providing/receiving new PDCCH monitoring limits for punctured candidates and non-punctured candidates separately.

According to still other embodiments, a method includes defining/providing/receiving new PDCCH monitoring limits for punctured, non-punctured and total (both kinds) of candidates. The resulting limit is the maximum of the monitored limits of punctured and non-punctured candidates.

### SSB Parameters

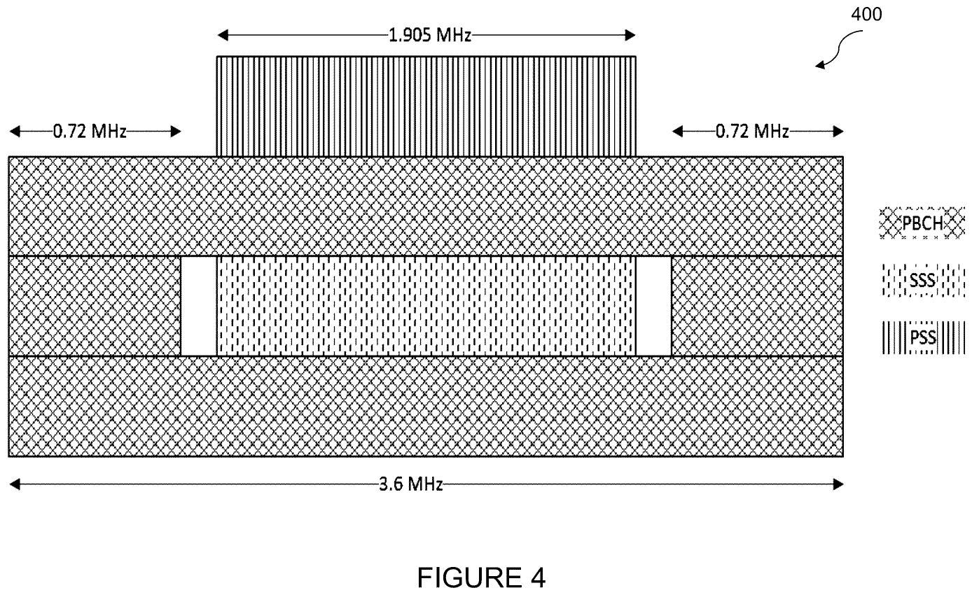

FIG. 4 illustrates an example time frequency structure 400 of SSB, according to certain embodiments.

If the operating bandwidth is less than 3.6 MHz, the PBCH would require puncturing as shown in FIG. 4. Puncturing results in increasing the required Signal-to-Noise Ratio (SNR) to decode the PBCH at a desired performance level. SSB allows UE to synchronize to a cell. An increased requirement on the SNR means increased waiting time (latency) to decode the SSB and may even result in no access to a cell. According to previous methods and techniques, it is stated in 3GPP TS 38.213 v.17.3.0 that the UE assumes a SSB periodicity of 20 ms.

In a particular embodiment, it is proposed to redefine the assumption on SSB periodicity for initial cell search/selection for reduced bandwidth NR operation. For example, a new default SSB periodicity for reduced bandwidth NR operation is defined to be smaller than 20 ms, in a particular embodiment.

In a particular embodiment, it is proposed to limit the maximum allowed SSB periodicity for NR operation in narrow bandwidth. This affects limiting the RRC parameter ssb-PeriodicityServingCell.

In a particular embodiment, it is proposed to redefine the value of the maximum number of candidate SSBs in a half frame for NR operation in reduced bandwidth. For FR1, it is currently set to a maximum of 4 candidates. However, in a further particular embodiment, the value may be increased such as, for example, to 8 candidates. This requires updating the specifications related to the information fields ssb-PositionsInBurst in both parameters ServingCellConfigCommonSIB and ServingCellConfigCommon.

In a particular embodiment, it is proposed that for NR operation in reduced bandwidth the network transmits the same candidate SSB (same index) more than once within a half frame. Thus, the same SSB candidate is repeated within an SSB burst. Then, the UE soft combines the same candidate SSBs corresponding to different SSB transmissions within an SSB burst before decoding PBCH. The NW uses same precoder for transmitting same candidate SSB. UE assumes NW uses same precoder for transmitting same candidate SSB.

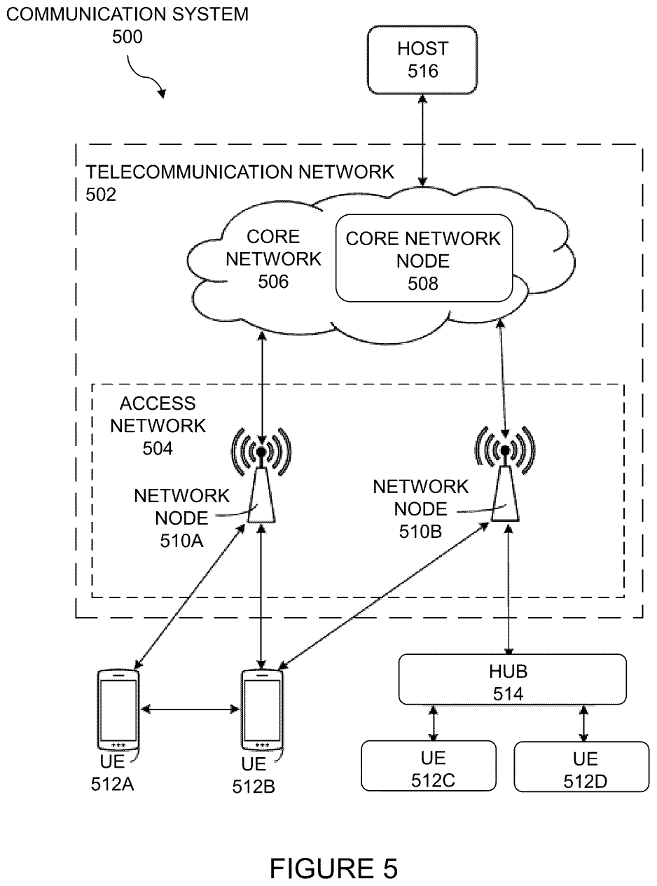

FIG. 5 shows an example of a communication system 500 in accordance with some embodiments. In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3^{rd} Generation Partnership Project (3GPP) access node or non-3GPP access point. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510b. In other embodiments, the hub 514 may be a non-dedicated hub—that is, a device which is capable of operating to route communications between the UEs and network node 510b, but which is additionally capable of operating as a communication start and/or end point for certain data channels.

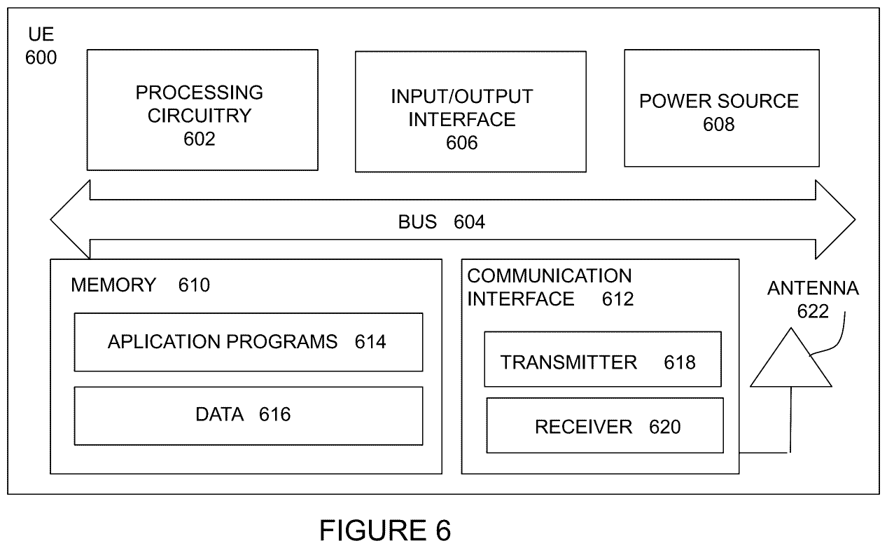

FIG. 6 shows a UE 600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

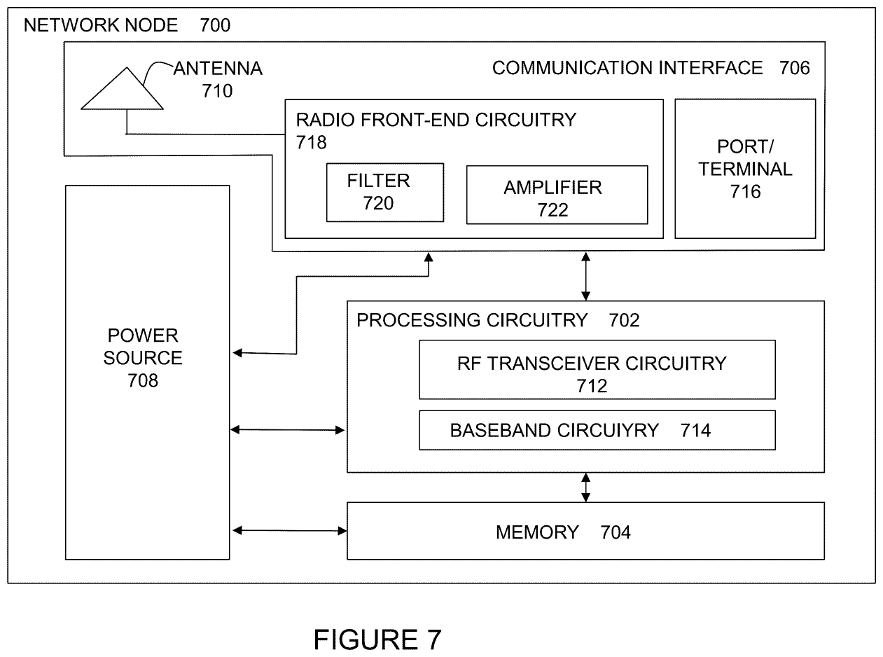

FIG. 7 shows a network node 700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, a part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

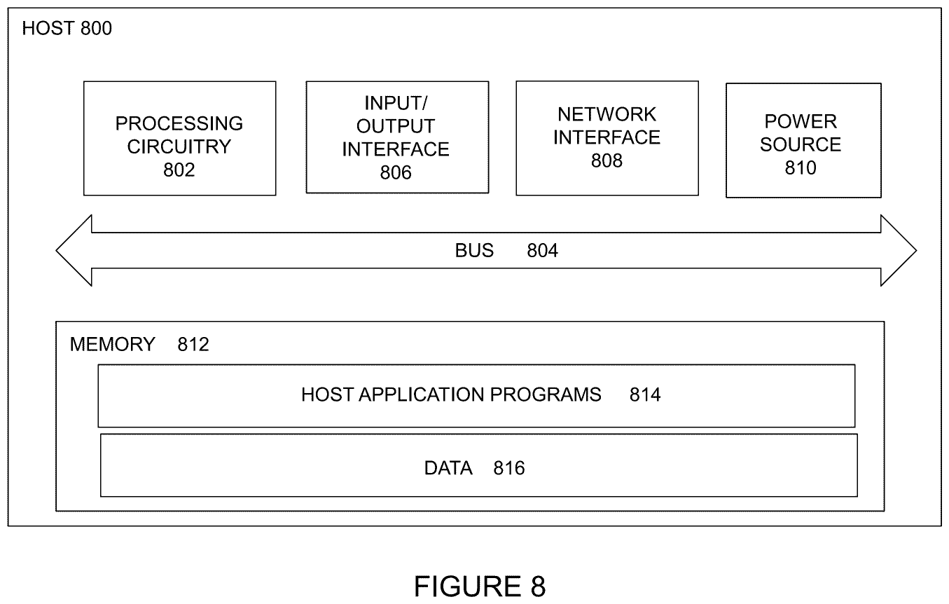

FIG. 8 is a block diagram of a host 800, which may be an embodiment of the host 516 of FIG. 5, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

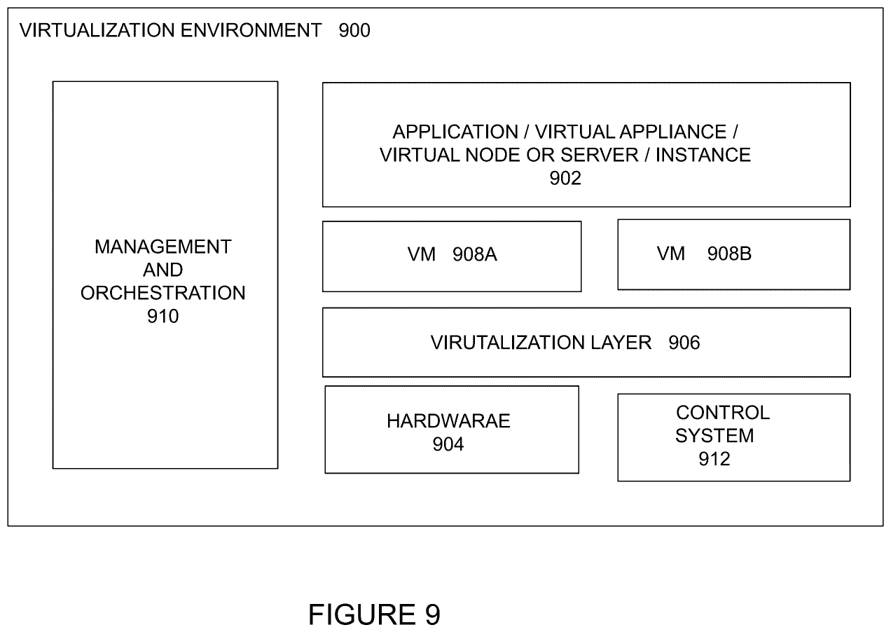

FIG. 9 is a block diagram illustrating a virtualization environment 900 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

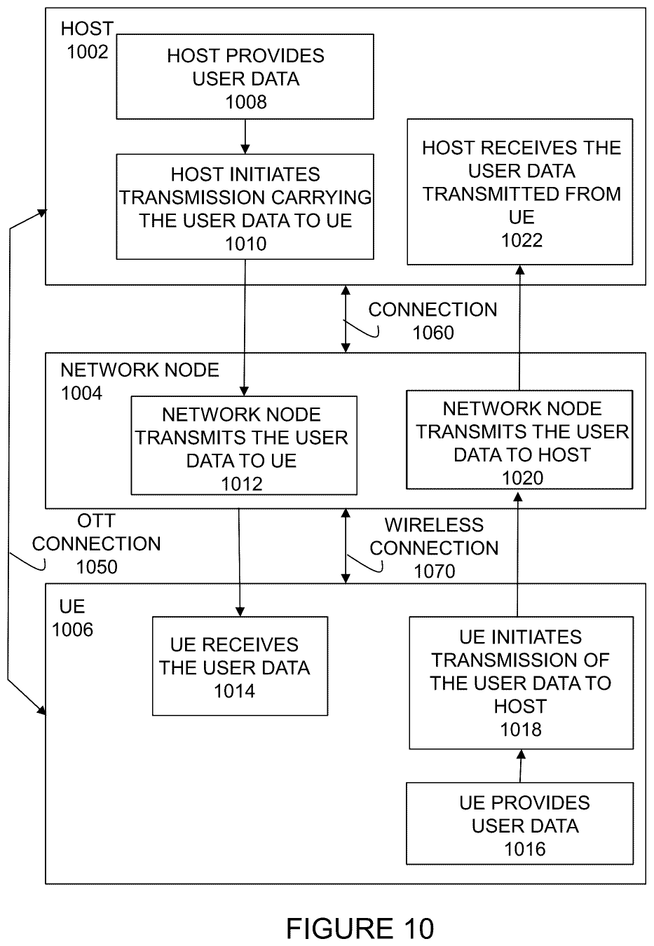

FIG. 10 shows a communication diagram of a host 1002 communicating via a network node 1004 with a UE 1006 over a partially wireless connection in accordance with some embodiments.

Example implementations, in accordance with various embodiments, of the UE (such as a UE 512a of FIG. 5 and/or UE 600 of FIG. 6), network node (such as network node 510a of FIG. 5 and/or network node 700 of FIG. 7), and host (such as host 516 of FIG. 5 and/or host 800 of FIG. 8) discussed in the preceding paragraphs will now be described with reference to FIG. 10.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 5) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

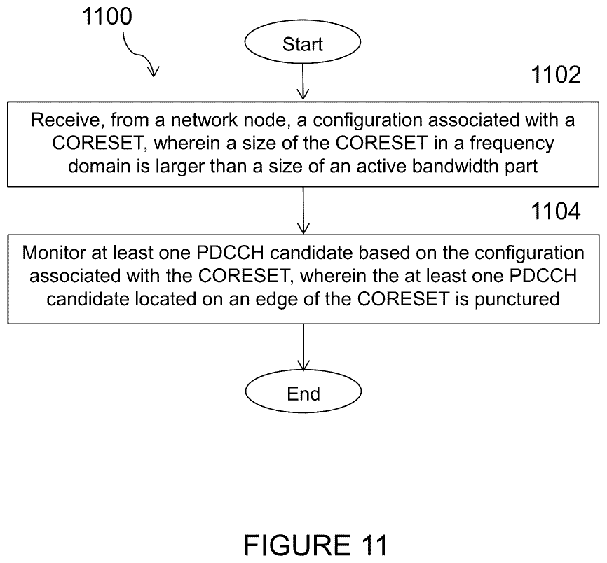

FIG. 11 illustrates a method 1100 by a UE 112 operating in a reduced channel bandwidth that is less than or equal to 5 MHz, according to certain embodiments. The method begins at step 1102 when the UE 112 receives, from a network node 110, a configuration associated with a CORESET. A size of the CORESET in a frequency domain is larger than a size of an active bandwidth part. At step 1104, the UE 112 monitors at least one PDCCH candidate based on the configuration associated with the CORESET. The at least one PDCCH candidate located on an edge of the CORESET is punctured.

In a particular embodiment, the UE 112 punctures at least one CCE that is not contained within an active bandwidth part.

In a particular embodiment, the at least one CCE that is punctured has an AL larger than 4.

In a particular embodiment, a ratio between a number of punctured CCEs of PDCCH candidates that can be decoded and a total number of CCEs is smaller than a threshold.

In a particular embodiment, the size of the CORESET in the frequency domain is larger than a size of an operating channel.

In a particular embodiment, the CORESET includes a number of physical resource blocks, PRBs, and wherein the number of PRBs is a multiple of three.

In a particular embodiment, the CORESET includes a number of PRBs, and the number of PRBs is not a multiple of six.

In a particular embodiment, the size of the CORESET is defined as a multiple of

$$\frac{6}{{N}_{symbol}^{CORESET}} P R B s , and {N}_{symbol}^{CORESET}$$

is a time duration of the CORESET in OFDM symbols.

In a particular embodiment, the at least one PDCCH candidate is generated based on a maximum allowed CORESET size.

In a particular embodiment, the at least one PDCCH candidate is selected such that a number of punctured PDCCH candidates is below a maximum threshold.

In a particular embodiment, the at least one PDCCH candidate is selected such that a number of punctured PDCCH candidates that can be decoded is set to a fixed number.

In a particular embodiment, the UE 112 applies a PDCCH monitoring limit to the at least one PDCCH candidate when the at least one PDCCH candidate is not punctured.

In a particular embodiment, the UE 112 applies a PDCCH monitoring limit to the at least one PDCCH candidate when the at least one PDCCH candidate has a number of punctured CCEs that is not greater than a maximum threshold.

In a particular embodiment, a CORESET CCE-to-REG mapping is based on the size of the CORESET.

In a particular embodiment, the size of the CORESET is

$$⌈ \frac{{N}_{BWP}}{6} ⌉ \times 6 P R B s ,$$

and N_{BWP} is a number of PRBs in an active bandwidth part of the reduced channel bandwidth.

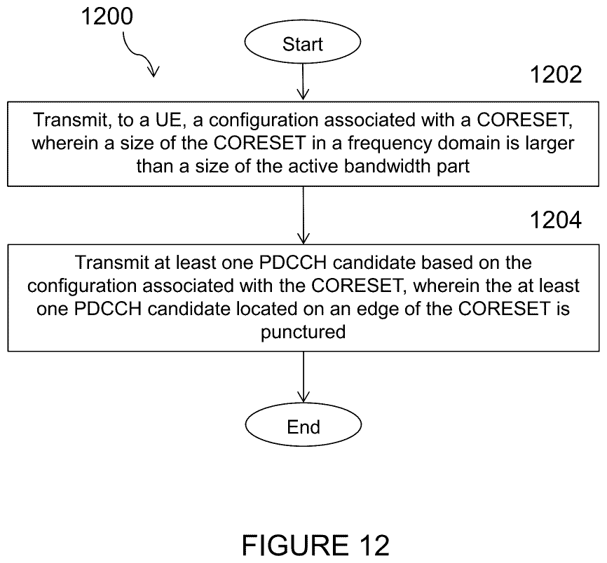

FIG. 12 illustrates a method 1200 by a network node 110 for configuring UE 112, operating in a reduced channel bandwidth that is less than or equal to 5 MHz, according to certain embodiments. The method begins at step 1202 when the network node 110 transmits, to the UE 112, a configuration associated with a CORESET. A size of the CORESET in a frequency domain is larger than a size of the active bandwidth part. At step 1204, the network node 110 transmits at least one PDCCH candidate based on the configuration associated with the CORESET. The at least one PDCCH candidate located on an edge of the CORESET is punctured.

In a particular embodiment, the network node 110 receives, from the UE 112, a size of the active bandwidth part and generates the CORESET based on the size of the active bandwidth part.

In a particular embodiment, when transmitting the at least one PDCCH candidate, the network node 110 punctures at least one CCE that is not contained within the active bandwidth part.

In a particular embodiment, the at least one CCE that are punctured have an AL larger than 4.

In a particular embodiment, the at least one PDCCH candidate is selected such that a ratio between a number of punctured CCEs of PDCCH candidates that can be decoded and a total number of CCEs smaller than a threshold.

In a particular embodiment, the size of the CORESET in the frequency domain is larger than a size of an operating channel.

In a particular embodiment, the CORESET includes number of PRBs, and the number of PRBs is a multiple of three.

In a particular embodiment, the CORESET comprises a number of PRBs and the number of PRBs is not a multiple of six.

In a particular embodiment, the size of the CORESET is defined as a multiple of

$$\frac{6}{{N}_{symbol}^{CORESET}} P R B s , and {N}_{symbol}^{CORESET}$$

is a time duration of the CORESET in OFDM symbols.

In a particular embodiment, the at least one PDCCH candidate is generated based on a maximum allowed CORESET size.

In a particular embodiment, the at least one PDCCH candidate is selected such that a number of punctured PDCCH candidates is below a maximum threshold.

In a particular embodiment, the at least one PDCCH candidate is selected such that a number of punctured PDCCH candidates that can be decoded is set to a fixed number.

In a particular embodiment, a CORESET CCE-to-REG mapping is based on a size of the CORESET.

In a particular embodiment, a size of the CORESET is

$$⌈ \frac{{N}_{BWP}}{6} ⌉ \times 6 P R B s$$

and N_{BWP} is a number of PRBs in the active bandwidth part of the reduced channel bandwidth.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) operating in a reduced channel bandwidth associated with an active bandwidth part, the method comprising: receiving, from a network node, a control resource set (CORESET) configuration, wherein a size of the CORESET in a frequency domain is larger than a size of the active bandwidth part.

Example Embodiment C2. The method of Example Embodiment C1, wherein the active bandwidth part comprises an active downlink bandwidth part.

Example Embodiment C3. The method of any one of Example Embodiments C1 to C2, wherein the reduced channel bandwidth is less than or equal to 5 MHz.

Example Embodiment C4. The method of any one of Example Embodiments C1 to C3, wherein the CORESET comprises a number of physical resource blocks, and wherein the number is not a multiple of six.

Example Embodiment C5. The method of any one of Example Embodiments C1 to C3, wherein the CORESET comprises a number of physical resource blocks, and wherein the number is a multiple of three.

Example Embodiment C6. The method of any one of Example Embodiments C1 to C3, wherein the size of the CORESET is defined as a multiple of

$$\frac{6}{{N}_{symbol}^{CORESET}} P R B s ,$$

where

$${N}_{symbol}^{CORESET}$$

is the time duration of the CORESET in OFDM symbols.

Example Embodiment C7. The method of any one of Example Embodiments C1 to C6, wherein the size of the CORESET that is larger than the size of the active bandwidth part is considered when generating at least one PDCCH candidate.

Example Embodiment C8. The method of any one of Example Embodiment C7, wherein the at least one PDCCH candidate is generated based on a maximum allowed CORESET size.

Example Embodiment C9. The method of any one of Example Embodiments C7 to C8, wherein the size of the CORESET is based on a CORESET CCE-to-REG mapping.

Example Embodiment C10. The method of any one of Example Embodiments C7 to C9, wherein the size of the CORESET is

$$⌈ \frac{{N}_{BWP}}{6} ⌉ \times 6 P R B s ,$$

where N_{BWP} is a number of PRBs in the active bandwidth part of the reduced bandwidth.

Example Embodiment C11. The method of any one of Example Embodiments C7 to C10, comprising puncturing any CCEs that are not contained within the active bandwidth part.

Example Embodiment C12. The method of any one of Example Embodiments C7 to C10, comprising puncturing any CCEs that are not contained within the active bandwidth part that have an AL larger than 4.

Example Embodiment C13. The method of any one of Example Embodiments C7 to C12, wherein the at least one PDCCH candidate is selected such that a number of punctured PDCCH candidates is below a maximum threshold.

Example Embodiment C14. The method of any one of Example Embodiments C7 to C13, wherein the at least one PDCCH candidate is selected such that a number of punctured PDCCH candidates is set to a fixed number.

Example Embodiment C15. The method of any one of Example Embodiments C7 to C14, wherein the at least one PDCCH candidate is selected such that any PDCCH candidates that are punctured are located on an edge of the CORESET.

Example Embodiment C16. The method of any one of Example Embodiments C7 to C15, wherein the at least one PDCCH candidate is selected such that a number of punctured PDCCH candidates is below a maximum threshold.

Example Embodiment C17. The method of any one of Example Embodiments C1 to C16, comprising applying a PDCCH monitoring limit only to the at least one PDCCH candidate if the at least one PDCCH candidate is non-punctured.

Example Embodiment C18. The method of any one of Example Embodiments C1 to C16, comprising applying a PDCCH monitoring limit only to the at least one PDCCH candidate if the at least one PDCCH candidate has a number of punctured CCEs that is not greater than a maximum threshold.

Example Embodiment C19. The method of Example Embodiments C1 to C18, further comprising: providing user data; and forwarding the user data to a host via the transmission to the network node.

Example Embodiment C20. A user equipment comprising processing circuitry configured to perform any of the methods of Example Embodiments C1 to C19.

Example Embodiment C21. A user equipment configured to perform any of the methods of Example Embodiments C1 to C19.

Example Embodiment C22. A wireless device comprising processing circuitry configured to perform any of the methods of Example Embodiments C1 to C19.

Example Embodiment C23. A computer program comprising instructions which when executed on a computer perform any of the methods of Example Embodiments C1 to C19.

Example Embodiment C24. A computer program product comprising computer program, the computer program comprising instructions which when executed on a computer perform any of the methods of Example Embodiments C1 to C19.

Example Embodiment C25. A non-transitory computer readable medium storing instructions which when executed by a computer perform any of the methods of Example Embodiments C1 to C19.

### Group D Example Embodiments

Example Embodiment D1. A method by a user equipment (UE) operating in a reduced channel bandwidth associated with an active bandwidth part, the method comprising: receiving, from a network node, a plurality of instances of a SSB candidate, wherein the plurality of instances of the same SSB candidate are received within a SSB burst.

Example Embodiment D2. The method of Example Embodiment D1, wherein the SSB burst is a half frame.

Example Embodiment D3. The method of any one of Example Embodiments D1 to D2, comprising soft combining the plurality of instances of the SSB candidate.

Example Embodiment D4. The method of any one of Example Embodiments D1 to D3, wherein a same precoder is used by the network node for each of the multiple instances of the SSB candidate.

Example Embodiment D5. The method of any one of Example Embodiments D1 to D4, wherein the UE assumes that a same precoder is used by the network node for each of the multiple instances of the SSB candidate.

Example Embodiment D6. The method of Example Embodiments D1 to D5, further comprising: providing user data; and forwarding the user data to a host via the transmission to the network node.

Example Embodiment D7. A user equipment comprising processing circuitry configured to perform any of the methods of Example Embodiments D1 to D6.

Example Embodiment D8. A user equipment configured to perform any of the methods of Example Embodiments D1 to D6.

Example Embodiment D9. A wireless device comprising processing circuitry configured to perform any of the methods of Example Embodiments D1 to D6.

Example Embodiment D10. A computer program comprising instructions which when executed on a computer perform any of the methods of Example Embodiments D1 to D6.

Example Embodiment D11. A computer program product comprising computer program, the computer program comprising instructions which when executed on a computer perform any of the methods of Example Embodiments D1 to D6.

Example Embodiment D12. A non-transitory computer readable medium storing instructions which when executed by a computer perform any of the methods of Example Embodiments D1 to D6.

### Group E Example Embodiments

Example Embodiment E1. A method by a network node for configuring a User Equipment (UE) operating in a reduced channel bandwidth associated with an active bandwidth part, the method comprising: transmitting, to the UE, a control resource set (CORESET) configuration, wherein a size of the CORESET in a frequency domain is larger than a size of the active bandwidth part.

Example Embodiment E2. The method of Example Embodiment E1, wherein the active bandwidth part comprises an active downlink bandwidth part.

Example Embodiment E3. The method of any one of Example Embodiments E1 to E2, wherein the reduced channel bandwidth is less than or equal to 5 MHz.

Example Embodiment E4. The method of any one of Example Embodiments E1 to E3, wherein the CORESET comprises a number of physical resource blocks, and wherein the number is not a multiple of six.

Example Embodiment E5. The method of any one of Example Embodiments E1 to E3, wherein the CORESET comprises a number of physical resource blocks, and wherein the number is a multiple of three.

Example Embodiment E6. The method of any one of Example Embodiments E1 to E3, wherein the size of the CORESET is defined as a multiple of

$$\frac{6}{{N}_{symbol}^{CORESET}} P R B s ,$$

where

$${N}_{symbol}^{CORESET}$$

is the time duration of the CORESET in OFDM symbols.

Example Embodiment E7. The method of any one of Example Embodiments E1 to E6, wherein the size of the CORESET that is larger than the size of the active bandwidth part is considered when generating at least one PDCCH candidate.

Example Embodiment E8. The method of any one of Example Embodiment C7, wherein the at least one PDCCH candidate is generated based on a maximum allowed CORESET size.

Example Embodiment E9. The method of any one of Example Embodiments E7 to E8, wherein the size of the CORESET is based on a CORESET CCE-to-REG mapping.

Example Embodiment E10. The method of any one of Example Embodiments E7 to E9, wherein the size of the CORESET is

$$⌈ \frac{{N}_{BWP}}{6} ⌉ \times 6 P R B s ,$$

where N_{BWP} is a number of PRBs in the active bandwidth part of the reduced bandwidth.

Example Embodiment E11. The method of any one of Example Embodiments E7 to E10, comprising puncturing any CCEs that are not contained within the active bandwidth part.

Example Embodiment E12. The method of any one of Example Embodiments E7 to E10, comprising puncturing any CCEs that are not contained within the active bandwidth part that have an AL larger than 4.

Example Embodiment E13. The method of any one of Example Embodiments E7 to E12, wherein the at least one PDCCH candidate is selected such that a number of punctured PDCCH candidates is below a maximum threshold.

Example Embodiment E14. The method of any one of Example Embodiments E7 to E13, wherein the at least one PDCCH candidate is selected such that a number of punctured PDCCH candidates is set to a fixed number.

Example Embodiment E15. The method of any one of Example Embodiments E7 to E14, wherein the at least one PDCCH candidate is selected such that any PDCCH candidates that are punctured are located on an edge of the CORESET.

Example Embodiment E16. The method of any one of Example Embodiments E7 to E15, wherein the at least one PDCCH candidate is selected such that a number of punctured PDCCH candidates is below a maximum threshold.

Example Embodiment E17. The method of any one of Example Embodiments E1 to E16, comprising applying a PDCCH monitoring limit only to the at least one PDCCH candidate if the at least one PDCCH candidate is non-punctured.

Example Embodiment E18. The method of any one of Example Embodiments E1 to E16, comprising applying a PDCCH monitoring limit only to the at least one PDCCH candidate if the at least one PDCCH candidate has a number of punctured CCEs that is not greater than a maximum threshold.

Example Embodiment E19. The method of any one of Example Embodiments E1 to E18, comprising: receiving, from the UE, the size of the active bandwidth part; and generating the CORESET based on the size of the active bandwidth part.

Example Embodiment E20. The method of any one of Example Embodiments E1 to E19, wherein the network node comprises a gNodeB (gNB).

Example Embodiment E21. The method of any of the previous Example Embodiments, further comprising: obtaining user data; and forwarding the user data to a host or a user equipment.

Example Embodiment E22. A network node comprising processing circuitry configured to perform any of the methods of Example Embodiments E1 to E21.

Example Embodiment E23. A network node configured to perform any of the methods of Example Embodiments E1 to E21.

Example Embodiment E24. A computer program comprising instructions which when executed on a computer perform any of the methods of Example Embodiments E1 to E21.

Example Embodiment E25. A computer program product comprising computer program, the computer program comprising instructions which when executed on a computer perform any of the methods of Example Embodiments E1 to E21.

Example Embodiment E26. A non-transitory computer readable medium storing instructions which when executed by a computer perform any of the methods of Example Embodiments E1 to E21.

### Group F Example Embodiments

Example Embodiment F1. A method by a network node for configuring a User Equipment (UE) operating in a reduced channel bandwidth associated with an active bandwidth part, the method comprising: transmitting, to the UE, a plurality of instances of a SSB candidate, wherein the plurality of instances of the same SSB candidate are received within a SSB burst.

Example Embodiment F2. The method of Example Embodiment F1, wherein the SSB burst is a half frame.

Example Embodiment F3. The method of any one of Example Embodiments F1 to F2, comprising configuring the UE to soft combine the plurality of instances of the SSB candidate.

Example Embodiment F4. The method of any one of Example Embodiments F1 to F3, wherein a same precoder is used by the network node for each of the multiple instances of the SSB candidate.

Example Embodiment F5. The method of any one of Example Embodiments F1 to F4, wherein the network node comprises a gNodeB (gNB).

Example Embodiment F6. The method of any of the previous Example Embodiments, further comprising: obtaining user data; and forwarding the user data to a host or a user equipment.

Example Embodiment F7. A network node comprising processing circuitry configured to perform any of the methods of Example Embodiments F1 to F6.

Example Embodiment F8. A network node configured to perform any of the methods of Example Embodiments F1 to F6.

Example Embodiment F9. A computer program comprising instructions which when executed on a computer perform any of the methods of Example Embodiments F1 to F6.

Example Embodiment F10. A computer program product comprising computer program, the computer program comprising instructions which when executed on a computer perform any of the methods of Example Embodiments F1 to F6.

Example Embodiment F11. A non-transitory computer readable medium storing instructions which when executed by a computer perform any of the methods of Example Embodiments F1 to F6.

### Group G Example Embodiments

Example Embodiment G1. A user equipment comprising: processing circuitry configured to perform any of the steps of any of the Group A, C, and D Example Embodiments; and power supply circuitry configured to supply power to the processing circuitry.

Example Embodiment G2. A network node comprising: processing circuitry configured to perform any of the steps of any of the Group B, E, and F Example Embodiments; power supply circuitry configured to supply power to the processing circuitry.

Example Embodiment G3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A, C, and D Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment G4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A, C, and D Example Embodiments to receive the user data from the host.

Example Embodiment G5. The host of the previous Example Embodiment, wherein the cellular network further includes a network node configured to communicate with the UE to transmit the user data to the UE from the host.

Example Embodiment G6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment G8. The method of the previous Example Embodiment, further comprising: at the host, executing a host application associated with a client application executing on the UE to receive the user data from the UE.

Example Embodiment G9. The method of the previous Example Embodiment, further comprising: at the host, transmitting input data to the client application executing on the UE, the input data being provided by executing the host application, wherein the user data is provided by the client application in response to the input data from the host application.

Example Embodiment G10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A, C, and D Example Embodiments to transmit the user data to the host.

Example Embodiment G11. The host of the previous Example Embodiment, wherein the cellular network further includes a network node configured to communicate with the UE to transmit the user data from the UE to the host.

Example Embodiment G12. The host of the previous 2 Example Embodiments, wherein:
the processing circuitry of the host is configured to execute a host application, thereby providing the user data; and the host application is configured to interact with a client application executing on the UE, the client application being associated with the host application.

Example Embodiment G13. A method implemented by a host configured to operate in a communication system that further includes a network node and a user equipment (UE), the method comprising: at the host, receiving user data transmitted to the host via the network node by the UE, wherein the UE performs any of the steps of any of the Group A, C, and D Example Embodiments to transmit the user data to the host.

Example Embodiment G14. The method of the previous Example Embodiment, further comprising: at the host, executing a host application associated with a client application executing on the UE to receive the user data from the UE.

Example Embodiment G15. The method of the previous Example Embodiment, further comprising: at the host, transmitting input data to the client application executing on the UE, the input data being provided by executing the host application, wherein the user data is provided by the client application in response to the input data from the host application.

Example Embodiment G16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, E, and F Example Embodiments to transmit the user data from the host to the UE.

Example Embodiment G17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment G18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, E, and F Example Embodiments to transmit the user data from the host to the UE.

Example Embodiment G19. The method of the previous Example Embodiment, further comprising, at the network node, transmitting the user data provided by the host for the UE.

Example Embodiment G20. The method of any of the previous 2 Example Embodiments, wherein the user data is provided at the host by executing a host application that interacts with a client application executing on the UE, the client application being associated with the host application.

Example Embodiment G21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, E, and F Example Embodiments to transmit the user data from the host to the UE.

Example Embodiment G22. The communication system of the previous Example Embodiment, further comprising: the network node; and/or the user equipment.

Example Embodiment G23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, E, and F Example Embodiments to receive the user data from a user equipment (UE) for the host.

Example Embodiment G24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G25. The host of the any of the previous 2 Example Embodiments, wherein the initiating receipt of the user data comprises requesting the user data.

Example Embodiment G26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, E, and F Example Embodiments to receive the user data from the UE for the host.

Example Embodiment G27. The method of the previous Example Embodiment, further comprising at the network node, transmitting the received user data to the host.

1. A method (1100) by a user equipment, UE (112), operating in a reduced channel bandwidth that is less than or equal to 5 MHz, the method comprising:
receiving (1102), from a network node (110), a configuration associated with a control resource set, CORESET, wherein a size of the CORESET in a frequency domain is larger than a size of an active bandwidth part; and
monitoring (1104) at least one Physical Downlink Control Channel, PDCCH, candidate based on the configuration associated with the CORESET, wherein the at least one PDCCH candidate located on an edge of the CORESET is punctured.

2. The method of claim 1, comprising puncturing at least one Control Channel Element, CCE, that is not contained within an active bandwidth part.

3. The method of claim 2, wherein the at least one CCE that is punctured has an Aggregation Level, AL, larger than 4.

4. The method of any one of claims 2 to 4, wherein a ratio between a number of punctured CCEs of PDCCH candidates that can be decoded and a total number of CCEs is smaller than a threshold.

5. The method of any one of claims 1 to 4, wherein the size of the CORESET in the frequency domain is larger than a size of an operating channel.

6. The method of any one of claims 1 to 5, wherein the CORESET comprises a number of physical resource blocks, PRBs, and wherein the number of PRBs is a multiple of three.

7. The method of any one of claims 1 to 5, wherein the CORESET comprises a number of physical resource blocks, PRBs, and wherein the number of PRBs is not a multiple of six.

8. The method of any one of claims 1 to 5, wherein the size of the CORESET is defined as a multiple of
$$\frac{6}{{N}_{symbol}^{CORESET}} Physical Resource Blocks ,$$
PRBs, and wherein
$${N}_{symbol}^{CORESET}$$
is a time duration of the CORESET in Orthogonal Frequency Division Multiplexing, OFDM, symbols.

9. The method of any one of claims 1 to 8, wherein the at least one PDCCH candidate is generated based on a maximum allowed CORESET size.

10. The method of any one of claims 1 to 9, wherein the at least one PDCCH candidate is selected such that a number of punctured PDCCH candidates is below a maximum threshold.

11. The method of any one of claims 1 to 10, wherein the at least one PDCCH candidate is selected such that a number of punctured PDCCH candidates that can be decoded is set to a fixed number.

12. The method of any one of claims 1 to 11, comprising applying a PDCCH monitoring limit to the at least one PDCCH candidate when the at least one PDCCH candidate is not punctured.

13. The method of any one of claims 1 to 11, comprising applying a PDCCH monitoring limit to the at least one PDCCH candidate when the at least one PDCCH candidate has a number of punctured CCEs that is not greater than a maximum threshold.

14. The method of any one of claims 1 to 13, wherein a CORESET Control Channel Element-to-Resource Element Group, CCE-to-REG, mapping is based on the size of the CORESET.

15. The method of any one of claims 1 to 14, wherein the size of the CORESET is
$$⌈ \frac{{N}_{BWP}}{6} ⌉ \times 6 Physical Resource Blocks ,$$
PRBs, and wherein N_{BWP} is anumber of PRBs in an active bandwidth part of the reduced channel bandwidth.

16. A method (1200) by a network node (110) for configuring a User Equipment, UE (112), operating in a reduced channel bandwidth that is less than or equal to 5 MHz, the method comprising:
transmitting (1202), to the UE, a configuration associated with a control resource set, CORESET, wherein a size of the CORESET in a frequency domain is larger than a size of the active bandwidth part; and
transmitting (1204) at least one Physical Downlink Control Channel, PDCCH candidate based on the configuration associated with the CORESET, wherein the at least one PDCCH candidate located on an edge of the CORESET is punctured.

17. The method of claim 16, comprising:
receiving, from the UE, a size of the active bandwidth part; and
generating the CORESET based on the size of the active bandwidth part.

18. The method of any one of claims 16 to 17, wherein transmitting the at least one PDCCH candidate comprises puncturing at least one Control Channel Element, CCE, that is not contained within the active bandwidth part.

19. The method of claim 18, wherein the at least one CCE that are punctured have an Aggregation Level, AL, larger than 4.

20. The method of any one of claims 18 to 19, wherein the at least one PDCCH candidate is selected such that a ratio between a number of punctured CCEs of PDCCH candidates that can be decoded and a total number of CCEs smaller than a threshold.

21. The method of any one of claims 16 to 20, wherein the size of the CORESET in the frequency domain is larger than a size of an operating channel.

22. The method of any one of claims 16 to 21, wherein the CORESET comprises a number of physical resource blocks, PRBs, and wherein the number of PRBs is a multiple of three.

23. The method of any one of claims 16 to 21, wherein the CORESET comprises a number of physical resource blocks, PRBs, and wherein the number of PRBs is not a multiple of six.

24. The method of any one of claims 16 to 21, wherein the size of the CORESET is defined as a multiple of
$$\frac{6}{{N}_{symbol}^{CORESET}} Physical Resource Blocks ,$$
PRBs, and wherein
$${N}_{symbol}^{CORESET}$$
is a time duration of the CORESET in Orthogonal Frequency Division Multiplexing, OFDM, symbols.

25. The method of any one of claims 16 to 24, wherein the at least one PDCCH candidate is generated based on a maximum allowed CORESET size.

26. The method of any one of Claims 16 to 24, wherein the at least one PDCCH candidate is selected such that a number of punctured PDCCH candidates is below a maximum threshold.

27. The method of any one of claims 16 to 25, wherein the at least one PDCCH candidate is selected such that a number of punctured PDCCH candidates that can be decoded is set to a fixed number.

28. The method of any one of claims 16 to 27, wherein a CORESET Control Channel Element-to-Resource Element Group, CCE-to-REG, mapping is based on a size of the CORESET.

29. The method of any one of claims 16 to 28, wherein a size of the CORESET is
$$⌈ \frac{{N}_{BWP}}{6} ⌉ \times 6 Physical Resource Blocks ,$$
PRBs, where N_{BWP} is a number of PRBs in the active bandwidth part of the reduced channel bandwidth.

30. A user equipment, UE (112), operating in a reduced channel bandwidth that is less than or equal to 5 MHz, the UE configured to:
receive, from a network node (110), a configuration associated with a control resource set, CORESET, wherein a size of the CORESET in a frequency domain is larger than a size of an active bandwidth part; and
monitor at least one Physical Downlink Control Channel, PDCCH, candidate based on the configuration associated with the CORESET, wherein the at least one PDCCH candidate located on an edge of the CORESET is punctured.

31. The UE of claim 30, configured to perform any of the methods of claims 2 to 15.

32. A network node (110) for configuring a User Equipment, UE (112), operating in a reduced channel bandwidth that is less than or equal to 5 MHz, the network node configured to:
transmit, to the UE, a configuration associated with a control resource set, CORESET, wherein a size of the CORESET in a frequency domain is larger than a size of an active bandwidth part; and
transmit at least one Physical Downlink Control Channel, PDCCH candidate based on the configuration associated with the CORESET, wherein the at least one PDCCH candidate located on an edge of the CORESET is punctured.

33. The network node of claim 32, configured to perform any of the methods of claims 17 to 29.

1. A method by a user equipment, UE, operating in a reduced channel bandwidth that is less than or equal to 5 MHz, the method comprising:
receiving, from a network node, a configuration associated with a control resource set, CORESET, wherein a size of the CORESET in a frequency domain is larger than a size of an active bandwidth part; and
monitoring at least one Physical Downlink Control Channel, PDCCH, candidate based on the configuration associated with the CORESET, wherein the at least one PDCCH candidate located on an edge of the CORESET is punctured.

2. The method of claim 1, comprising puncturing at least one Control Channel Element, CCE, that is not contained within an active bandwidth part.

3. The method of claim 2, wherein the at least one CCE that is punctured has an Aggregation Level, AL, larger than 4.

4. The method of claim 2, wherein a ratio between a number of punctured CCEs of PDCCH candidates that can be decoded and a total number of CCEs is smaller than a threshold.

5. The method of claim 1, wherein the size of the CORESET in the frequency domain is larger than a size of an operating channel.

6. The method of claim 1, wherein the CORESET comprises a number of physical resource blocks, PRBs, and wherein the number of PRBs is a multiple of three.

7. The method of claim 1, wherein the CORESET comprises a number of physical resource blocks, PRBs, and wherein the number of PRBs is not a multiple of six.

8. The method of claim 1, wherein the size of the CORESET is defined as a multiple of
$$\frac{6}{{N}_{symbol}^{CORESET}} Physical Resource Blocks ,$$
PRBs, and wherein
$${N}_{symbol}^{CORESET}$$
is a time duration of the CORESET in Orthogonal Frequency Division Multiplexing, OFDM, symbols.

9. The method of claim 1 wherein the at least one PDCCH candidate is generated based on a maximum allowed CORESET size.

10. The method of claim 1, wherein the at least one PDCCH candidate is selected such that a number of punctured PDCCH candidates is below a maximum threshold.

11. The method of claim 1, wherein the at least one PDCCH candidate is selected such that a number of punctured PDCCH candidates that can be decoded is set to a fixed number.

12. The method of claim 1, comprising applying a PDCCH monitoring limit to the at least one PDCCH candidate when the at least one PDCCH candidate is not punctured.

13. The method of claim 1, comprising applying a PDCCH monitoring limit to the at least one PDCCH candidate when the at least one PDCCH candidate has a number of punctured CCEs that is not greater than a maximum threshold.

14. The method of claim 1, wherein a CORESET Control Channel Element-to-Resource Element Group, CCE-to-REG, mapping is based on the size of the CORESET.

15. The method of claim 1, wherein the size of the CORESET is
$$⌈ \frac{{N}_{BWP}}{6} ⌉ \times 6 Physical Resource Blocks ,$$
PRBs, and wherein N_{BWP} is a number of PRBs in an active bandwidth part of the reduced channel bandwidth.

16. A method by a network node for configuring a User Equipment, UE, operating in a reduced channel bandwidth that is less than or equal to 5 MHz, the method comprising:
transmitting, to the UE, a configuration associated with a control resource set, CORESET, wherein a size of the CORESET in a frequency domain is larger than a size of the active bandwidth part; and
transmitting at least one Physical Downlink Control Channel, PDCCH candidate based on the configuration associated with the CORESET, wherein the at least one PDCCH candidate located on an edge of the CORESET is punctured.

17. The method of claim 16, comprising:
receiving, from the UE, a size of the active bandwidth part; and
generating the CORESET based on the size of the active bandwidth part.

18. The method of claim 16, wherein transmitting the at least one PDCCH candidate comprises puncturing at least one Control Channel Element, CCE, that is not contained within the active bandwidth part.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A user equipment, UE operating in a reduced channel bandwidth that is less than or equal to 5 MHz, the UE configured to:
receive, from a network node, a configuration associated with a control resource set, CORESET, wherein a size of the CORESET in a frequency domain is larger than a size of an active bandwidth part; and
monitor at least one Physical Downlink Control Channel, PDCCH, candidate based on the configuration associated with the CORESET, wherein the at least one PDCCH candidate located on an edge of the CORESET is punctured.

31. (canceled)

32. A network node for configuring a User Equipment, UE, operating in a reduced channel bandwidth that is less than or equal to 5 MHz, the network node configured to:
transmit, to the UE, a configuration associated with a control resource set, CORESET, wherein a size of the CORESET in a frequency domain is larger than a size of an active bandwidth part; and
transmit at least one Physical Downlink Control Channel, PDCCH candidate based on the configuration associated with the CORESET, wherein the at least one PDCCH candidate located on an edge of the CORESET is punctured.

33. (canceled)
